(19) United States
(12) Patent Application Publication
(10) Pub. No.: US 2012/0071217 A1
(43) Pub. Date: Mar. 22, 2012

(54) PROTECTOR FOR SMARTPHONE

(76) Inventor: Han Jong PARK, Daegu-City (KR)

(21) Appl. No.: 12/949,382

(22) Filed: Nov. 18, 2010

(30) Foreign Application Priority Data
Sep. 17, 2010 (KR) 10-2010-0091924

(51) Int. Cl. H04M 1/00

(52) U.S. Cl. 455/575.8

(57) ABSTRACT

A protector for smartphones includes a cover located on the entire front face of a smartphone and constructed to have the same width as an LCD screen of the smartphone, the cover having through holes for exposing touch buttons and a speaker of the smartphone to the outside; and a main body made of a soft synthetic resin with flexibility, the main body having a space for accommodating the back of the smartphone, a retaining portion for fastening an outer edge of the cover located on the front face of the smartphone, and a through hole formed on a rear face thereof for exposing a camera of the smartphone to the outside.

### BACKGROUND OF THE INVENTION

1. Field of the Invention

The present invention relates to a protector for smartphones, which can protect a smartphone that offers not only mobile phone functions but also computer functions, such as installation and running of various kinds of applications and information retrieval, and more particularly, to a protector for smartphones, which includes a cover made of tempered glass and constructed to cover an entire front face of the smartphone and a body located on the back of the smartphone for accommodating the smartphone and the cover.

2. Background Art

In general, a smartphone is a mobile communication terminal that has a mobile phone function, which lets a user make telephone calls to a general phone or another mobile phone terminal through a base station while the user is moving, and computer functions, which allows the user to install and run wanted applications by accessing the Web through wireless Internet.

In order to effectively use such computer functions as described above, the smartphone must have a relatively wide LCD screen and a more enhanced strength of the LCD screen to minimize damages due to external shocks.

That is, because the smartphone displays the computer functions on the LCD screen, the LCD screen is a critical component in executing the functionality of the smartphone differently from other feature phones, and hence, it is important to keep it clean and endurable to the external shocks for a long time. For this, the LCD screen of the smartphone is generally made of glass.

However, even though the LCD screen of the smartphone is made of glass, scratches may frequently occur on the surface of the LCD screen resulting from friction caused by a fingernail when the user touches buttons or friction caused by other foreign substances or damages by external shocks, for instance, a crack of the LCD screen.

As described above, because the LCD screen is a very important component in the nature of the smartphone functions, if there occurs any damage on the LCD screen, it is necessary to take follow-up measures, for instance, to replace the LCD screen. However, because it is too expensive to replace the LCD screen, various technologies to protect the LCD screen before the LCD screen is damaged have been developed and used.

One of the technologies to protect the LCD screen is a method of adhering a protective film on the LCD screen.

However, the protective film to protect the LCD screen can prevent scratches on the surface of the LCD screen by preventing friction caused by foreign substances, but cannot prevent that the LCD screen is damaged by external shocks because it cannot withstand strong shocks.

### SUMMARY OF THE INVENTION

Accordingly, the present invention has been made to solve the above-mentioned problems occurring in the prior arts, and it is an object of the present invention to provide a protector for smartphones, which includes a cover made of tempered glass and constructed to cover an entire front face of the smartphone and a body located on the back of the smartphone for accommodating the smartphone and the cover, thereby protecting an LCD screen from external shocks with the cover made of tempered glass and easily fixing the cover on the LCD screen of the smartphone.

To accomplish the above object, according to the present invention, there is provided a protector for smartphones comprising: a cover located on the entire front face of a smartphone and constructed to have the same width as an LCD screen of the smartphone, the cover having through holes for exposing touch buttons and a speaker of the smartphone to the outside; and a main body made of a soft synthetic resin with flexibility, the main body having a space for accommodating the back of the smartphone, a retaining portion for fastening an outer edge of the cover located on the front face of the smartphone, and a through hole formed on a rear face thereof for exposing a camera of the smartphone to the outside.

Moreover, it is preferable that the cover is made of tempered glass or reinforced plastics.

As described above, the protector for smartphones according to the present invention includes the cover located on the entire front face of the smartphone and the main body constructed for accommodating the cover and the smartphone therein. Accordingly, because the protector is fixed on the smartphone in a state where the smartphone and the cover are accommodated in the main body thereof, the protector for smartphones can protect the LCD screen of the smartphone without a need to adhere the cover on the surface of the LCD screen of the smartphone and allow the LCD screen to clearly display images or contents because it leaves no sticky residue on the LCD screen of the smartphone, whereby it maximizes efficiency of the smartphone.

Furthermore, because the cover is made of tempered glass or reinforced plastics, it can prevent scratches on the LCD screen of the smartphone resulting from friction by foreign substances and protect the LCD screen and the body of the smartphone by absorbing external shocks generated by external friction or when the user drops the smartphone.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a preferable form of a protector for smartphones according to the present invention;

FIG. 2 is an exploded perspective view showing the preferable form of the protector for smartphones according to the present invention;

FIG. 3 is a sectional view showing the preferable form of the protector for smartphones according to the present invention; and

FIG. 4 is an exemplary view showing a preferable form of a retaining portion of the protector for smartphones according to the present invention.

### DETAILED DESCRIPTION OF THE PREFERRED EMBODIMENT

Reference will be now made in detail to the preferred embodiment of the present invention with reference to the attached drawings.

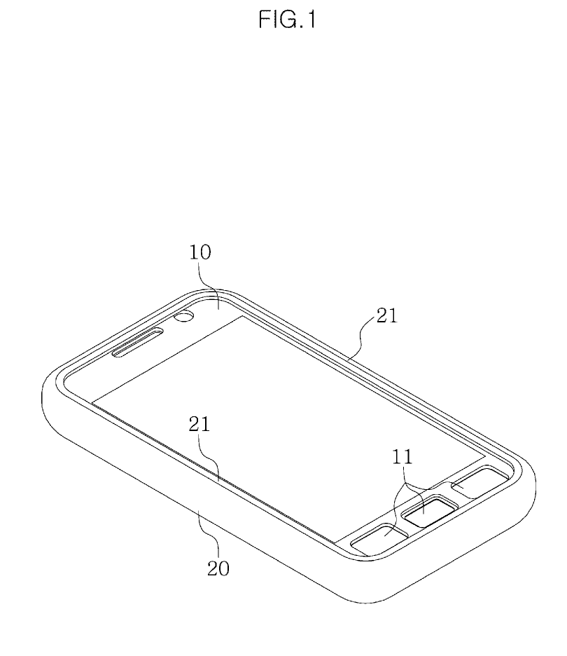

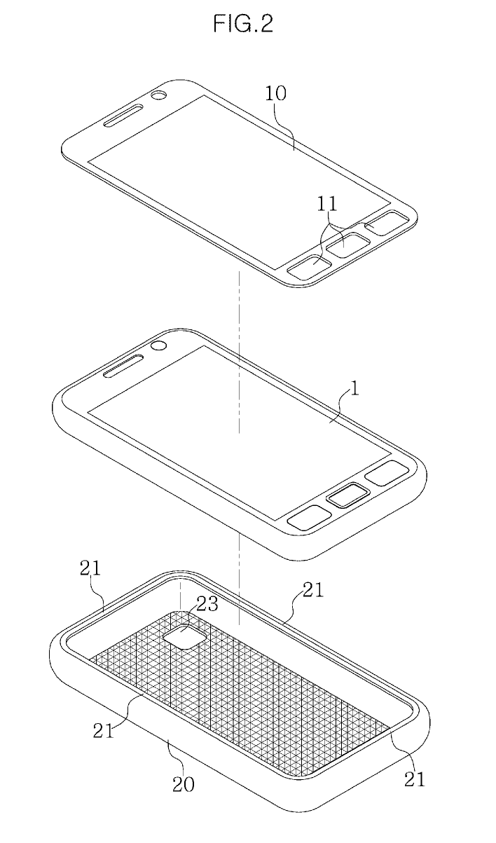

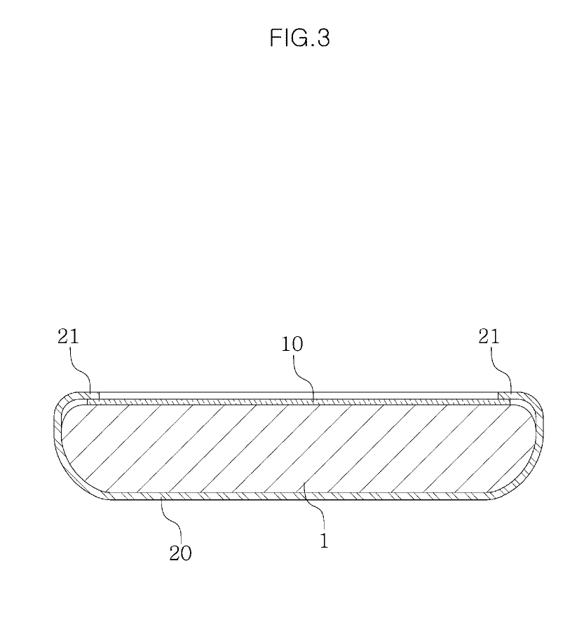

FIG. 1 is a perspective view showing a preferable form of a protector for smartphones according to the present invention, FIG. 2 is an exploded perspective view showing the preferable form of the protector for smartphones according to the present invention, and FIG. 3 is a sectional view showing the preferable form of the protector for smartphones according to the present invention. Referring to the drawings, the protector for smartphones according to the present invention is to prevent friction against foreign substances on the surface of an LCD screen of a smartphone 1 and protect the LCD screen thereof against external shocks.

For this, as shown in FIGS. 1, 2 and 3, the protector according to the present invention includes a cover 10 for protecting the entire front LCD screen of the smartphone 1 and a main body 20 for fixing the cover 10.

The cover 10 is located on the front face of the smartphone 1 to protect the entire front LCD screen of the smartphone 1, and hence, it has the same width as the entire surface of the LCD screen of the smartphone 1, and includes through holes 11 formed at positions corresponding to touch buttons and a speaker of the smartphone 1 to expose them to the outside, so that it can protect the LCD screen of the smart phone 1 and allow execution of smartphone functions.

Moreover, it is preferable the cover 10 is made of a transparent material in order to allow the user to see the contents displayed on the LCD screen of the smartphone 1.

The main body 20 is constructed to fasten the cover 10 located on the front face of the smartphone 1 and made of a soft synthetic resin with flexibility. The main body 20 includes a space located at the back of the smartphone 1 for accommodating the smartphone 1 therein, and a retaining portion 21 formed on a front end portion thereof for fastening the cover 10 located on the front face of the smartphone 1.

The space of the main body 20 for accommodating the smartphone 1 is formed small in consideration of a thickness and a width of the smartphone 1 in such a way that the smartphone 1 and the cover 10 accommodated in the main body 20 can be compressed and fixed together inside the main body 20.

Preferably, a width that the cover 10 is fastened to the retaining portion 21 of the main body 20 is in the range that the retaining portion 21 does not hide the touch buttons of the smartphone 1 and have any effect on the LCD screen.

Furthermore, the main body 20 further includes a through hole 23 formed on the back thereof to expose a camera of the smartphone 1 to the outside, so that the smartphone can execute its camera function.

Here, it is preferable that the cover 10 is made of tempered glass or reinforced plastics.

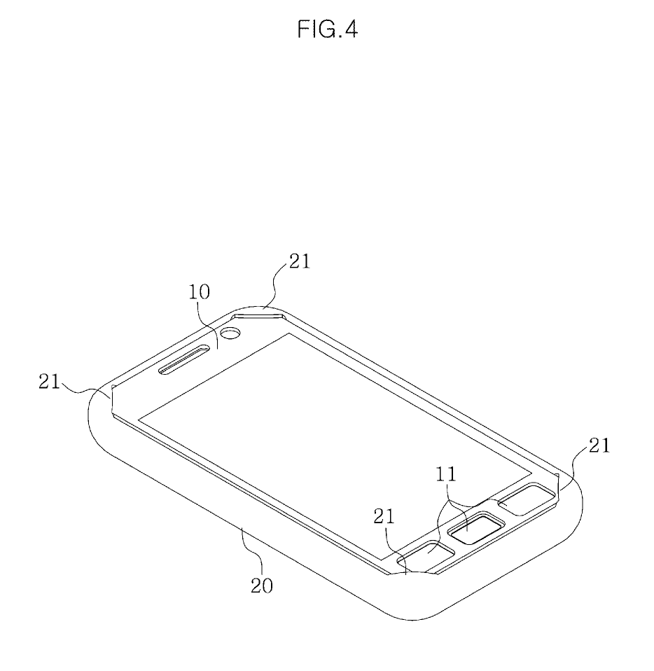

As shown in FIG. 4, the retaining portion 21 of the main body 20 may be constructed to fasten the whole of the outer edge of the cover 10 in order to offer a more stable fastening of the cover 10 or to fasten only corners of the cover 10 in order to more easily accommodate the cover 10 and the smartphone 1 in the main body 20.

Hereinafter, how to use the protector for smartphones according to the present invention will be described.

First, the cover 10 is located on the entire front screen of the smartphone 1. In more detail, the cover 10 is located on the front face of the smartphone 1 in such a way that the touch buttons and the speaker of the smartphone 1 can be exposed to the outside through the through holes 11 of the cover 10.

In a state where the cover 10 and the smartphone 1 are pressurized or grasped with the fingers in order to keep the state where the cover 10 is located on the LCD screen of the smartphone 1 in such a way that the touch buttons and the speaker of the smartphone 1 are exposed to the outside through the through holes 11, the smartphone 1 is accommodated into the main body 20 while the main body 20 is expanded as large as the rear port of the smartphone 1 can be accommodated in the main body 20, and then, the outer edge of the cover 10 is fastened to the main body 20 by the retaining portion 21 formed on the front end of the main body 20.

Because the space of the main body 20 for accommodating the smartphone 1 is small, the smartphone 1 and the cover 20 accommodated in the main body 20 can be fastened therein, and hence, the protector according to the present invention can protect the LCD screen of the smartphone 1 through the cover 10 without a need to adhere it on the surface of the LCD screen of the smartphone 1 and allow the LCD screen to clearly display images or contents without any sticky residue of the cover 10, thereby maximizing efficiency of the smartphone 1.

Additionally, because the cover 10 is made of tempered glass or reinforced plastics, the protector for smartphones according to the present invention can prevent scratches on the LCD screen of the smartphone resulting from the user's fingernail or friction by foreign substances, protect the LCD screen of the smartphone by absorbing external shocks, and allow the smartphone 1 to execute its functions because the through holes 11 of the cover 10 and the through hole 23 of the main body 20 expose the buttons, the speaker and the camera of the smartphone 1 to the outside.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A protector for smartphones comprising:
a cover (10) located on the entire front face of a smartphone (1) and constructed to have the same width as an LCD screen of the smartphone (1), the cover (10) having through holes (11) for exposing touch buttons and a speaker of the smartphone (1) to the outside; and
a main body (20) made of a soft synthetic resin with flexibility, the main body (20) having a space for accommodating the back of the smartphone (1), a retaining portion (21) for fastening an outer edge of the cover 10 located on the front face of the smartphone (1), and a through hole (23) formed on a rear face thereof for exposing a camera of the smartphone (1) to the outside.

2. The protector for smartphones according to claim 1, wherein the cover (10) is made of tempered glass or reinforced plastics.

3. The protector for smartphones according to claim 1, wherein the retaining portion (21) of the main body (20) is constructed to fasten the whole of the outer edge of the cover (10) or to fasten only corners of the cover (10).
